(19) United States
(12) Patent Application Publication
(10) Pub. No.: US 2010/0169903 A1
(43) Pub. Date: Jul. 1, 2010

(54) DRIVE SYSTEM FOR DRIVING A MOVABLE PART AND DISK DRIVE UNIT COMPRISING SUCH DRIVE SYSTEM

(75) Inventor: Waltherus Cornelis Jozef Bierhoff, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 12/063,238

(22) PCT Filed: Jul. 28, 2006
(86) PCT No.: PCT/IB2006/052587

§ 371 Date: Feb. 8, 2008

(30) Foreign Application Priority Data
Aug. 8, 2005 (EP) 05107284.1

(51) Int. Cl. G11B 7/00

(52) U.S. Cl. 720/681; G9B/7

(57) ABSTRACT

The invention provides a drive system for driving a lens holder (6) of the optical system in a disk drive unit. It comprises a movable part (8) connected to the lens holder, and a base (7) including a guide (9) for guiding the movable part. A drive motor comprises a stator (12) fixed with respect to the base and a translator (13) movable with respect to the stator upon actuation of the motor. A return mechanism (21) is connected between the translator and the movable part for bringing the rotor/translator in a starting position with respect to the movable part in a rest condition of the drive motor. A portion (18) of the movable part is in the path of movement of the translator, while there is a free stroke (20) between the portion of the movable part and the translator in the starting position of the translator. As a result, the translator will hit the movable part, thereby overcoming the static friction between the movable part and the base.

### BACKGROUND OF THE INVENTION

The present invention relates to a drive system for driving a movable part, comprising a base including a guide for guiding the movable part, and a drive motor comprising a stator fixed with respect to the base part and a rotor/translator movable with respect to the stator upon actuation of the motor.

Such drive system can be used in applications were small and accurate movements of the movable part are required. One of such applications is for example a drive system in an optical system for use with an optical disk drive. In such optical systems one or more lenses have to be able to move their position in relation to each other. This movement is mostly done with a drive system including an electric motor. It is common to equip such drive system with a rotational motor. Such motor drives the movable part through a transmission such as a gear or belt. A disadvantage of such type of drive is that play may occur in the transmission between the motor and the movable part. The transmission also increases the size of the drive system.

An alternative drive system in which these problems are avoided comprises a direct drive motor. In this case, the movable part is incorporated in the motor of the drive system and in case the movable part makes a translatory movement, a linear motor is an option.

A problem with linear motors is that they are not self-breaking, which requires constant activation of the motor to maintain the position of the movable part. This increases power consumption. A way of solving this problem and thus to maintain a position of the movable part without constantly energizing the motor, is to add friction between the movable part and the base. However, the disadvantage of this added friction is the introduction of static friction which differs substantially from dynamic friction. The static friction makes the linear motor less efficient due to the large current needed to overcome the static friction. Moreover, overshoot problems will be introduced when using such high currents.

It is an object of the present invention to provide a drive system in which the problem caused by static friction is solved in a simple and efficient manner.

### SUMMARY OF THE INVENTION

To obtain this object, the present invention provides a drive system for driving a movable part, comprising a base including a guide for guiding the movable part, a drive motor comprising a stator fixed with respect to the base and a rotor/translator movable with respect to the stator upon actuation of the motor, and a return mechanism connected between the rotor/translator and the movable part for bringing the rotor/translator in a starting position with respect to the movable part in a rest condition of the drive motor, wherein a portion of the movable part is in the path of movement of the rotor/translator, while there is a free stroke between the portion of the movable part and the rotor/translator in the starting position of the rotor/ translator.

By introducing a free stroke between the rotor/translator and the movable part, the rotor/translator is able to build up speed before it contacts the movable part. As a result, the mass of the rotor/translator will hit the movable part and due to this hitting the energy, loaded in the rotor/translator, is instantly transferred to the movable part and generates a shock wave. As a result of this shock wave, the static friction is overcome, also when the motor is energized at a relatively low level.

There are at least two ways in which the drive system according to the invention can be controlled. One manner is by energizing the motor constantly for a certain time which is sufficient for the movable part to arrive at the required position. Another way is to energize the motor with short pulses, preferably with a frequency matching the natural frequency of the drive system, so that the final position of the movable part is reached after a certain number of pulses.

Preferably the drive system is in accordance with claim 2, so that the movable part can be moved into opposite directions according to the same principle. In an electric motor, the direction of movement can easily be switched by switching the direction of the current.

Although the invention is very well suitable for rotary motors having a rotor, the main use will be that of claim 3, i.e. as a linear motor.

A simple embodiment of the drive system is defined in claim 4, wherein the return mechanism includes at least one spring member. The spring member may have all kind of shapes depending on the structure of the motor. In the particular embodiment as defined in claim 4, it is favourable if the spring member is substantially flat as is defined in claim 6, because such substantially flat spring will hardly increase the size of the drive system.

Preferably, the drive motor of the drive system according to the invention is an electric motor, such electric motor being conveniently as defined in claim 7, although other arrangements are conceivable.

The embodiment of the drive system according to claim 8 has the advantage that a translator magnet has an additional function in keeping the movable part and the base in sliding engagement. This also introduces the friction for the movable part which is desired for maintaining the position of the movable part after it has been moved.

One way of tuning the drive system is defined in claim 10, according to which a mass is attached to the magnet. By changing the weight of the mass (i.e. by arranging different types of masses) it is possible to vary the impulse magnitude.

The invention also includes a disk drive unit. The disk drive unit according to the invention is defined in claim 12.

These and other aspects of the invention will be apparent from the following description with reference to the drawings schematically showing embodiments of the invention by way of example.

### BRIEF DESCRIPTION OF THE DRAWINGS

FIG. 1 is a very schematic cross-section of a disk drive unit according to the invention.

FIG. 2 is a larger scale schematic plan view of the optical system in the device of FIG. 1.

FIGS. 3, 4, 5, 6 are a side view, a longitudinal sections view, a perspective bottom view and a perspective plan view, respectively, of an embodiment of the drive system in the optical system of FIG. 2, on a larger scale and with the base removed.

FIGS. 7 and 8 are a longitudinal sectional view and a perspective side view, respectively, of a second embodiment of the drive system according to the invention.

FIG. 9 is a perspective view of an alternative embodiment of a return spring for use in the drive system FIGS. 3-6.

### DETAILED DESCRIPTION OF PRESENTLY PREFERRED EMBODIMENTS

The drawings show an embodiment of a disk drive unit. This disk drive unit may be used in a device for reading and/or writing data from or on a disk, such as an optical disk or the like. The device in which this disk drive unit is used may be a portable or a stationary device, such as an audio or video player and/or recorder or a data disk reader and/or writer. The optical disk in this embodiment may be a high speed CD/DVD/Blu-Ray disk or the like.

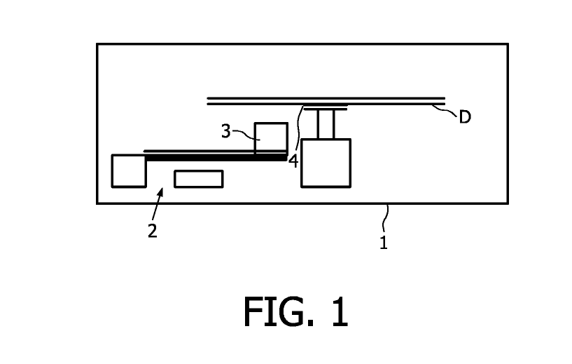

As shown in FIG. 1, the disk drive unit includes a housing 1 accommodating the disk drive unit. The disk drive unit comprises an optical system 2 including an optical pickup unit 3 and a driven turntable 4 for supporting a disk D.

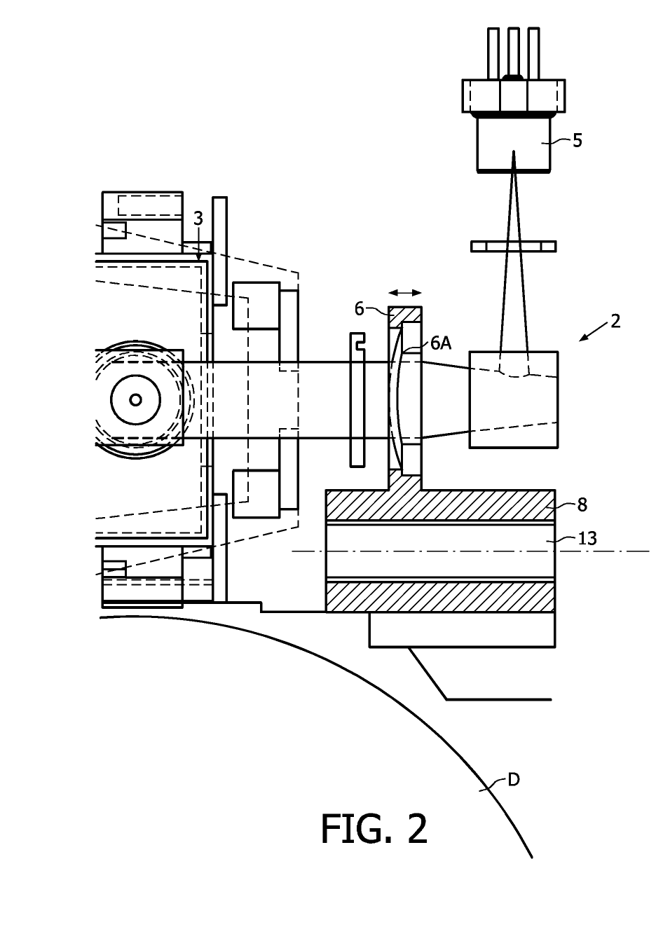

FIG. 2 shows the optical system 2 in some more detail. Depicted are the optical pickup unit 3 and also a laser source 5 for reading and/or writing information on the disk D. The light path between the laser source 5 and the disk D is determined by the optical system 2 comprising a plurality of mirrors and lenses. One lens 6A is displaceable by means of the drive system according to the invention. This lens 6A is a collimator lens which is used to determine on which layer in the optical disk D the laser light is focussed. By displacing this collimator lens 6A, the focal point of the laser system is switched to another layer in the disk D. A disk D may include several layers on which information can be stored. Some disks may even include up to 12 layers of information.

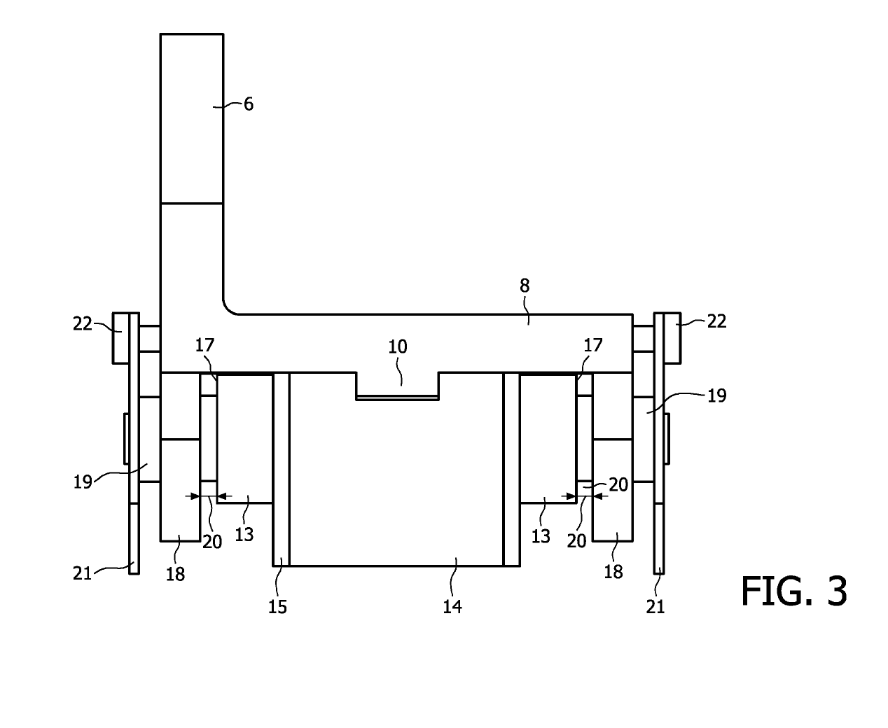

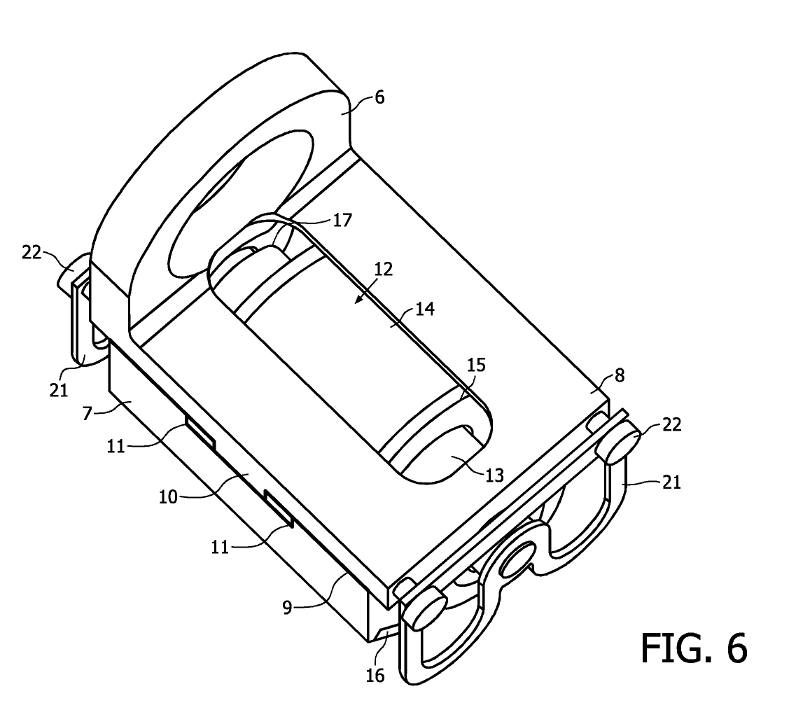

FIGS. 3-6 show the drive system in more detail and on a larger scale. The drive system includes a base 7 which is preferably fixed during operation of the drive system. This base 7 supports a movable part 8 which in this case is formed in one piece with a lens holder 6 holding the lens 6A. The movable part 8 is guided with respect to the base 7 by means of a rectilinear sliding guide 9 to enable the movable part 8 to make a translatory movement with respect to the base 7. The movable part comprises a projection 10 cooperating with two stop faces 11 on the base 7 in order to limit the maximum stroke of the lens holder 6.

The base 7 and movable part 8 substantially surround a motor including a coiled stator 12 and a translator in this example formed by a magnet 13. The stator 12 includes a coil 14 wound on a coil former 15. The coil former 15 is cylindrical and allows passage of the translator magnet 13. The coil 14 is connected to a voltage source which is able to direct a current with the desired pulse (pulse shape, pulse height, frequency etc.).

The translator magnet 13 not only cooperates with the coil 14 of the stator 12, but also with magnetizable members 16 in the base 7 which causes the magnet 13 to be attracted in a direction of the magnetizable members 16 thereby causing the movable part 8 to be brought and held in engagement with the base 7. This results in a pressure between the parts in the guide 9, so that there is created a static friction between the movable part 8 and the base 7 at the position of the guide 9. This static friction stabilizes the movable part 8 in the desired position, so that the drive system is self-breaking and it is not necessary to keep the drive system energized to hold the movable part in a certain position.

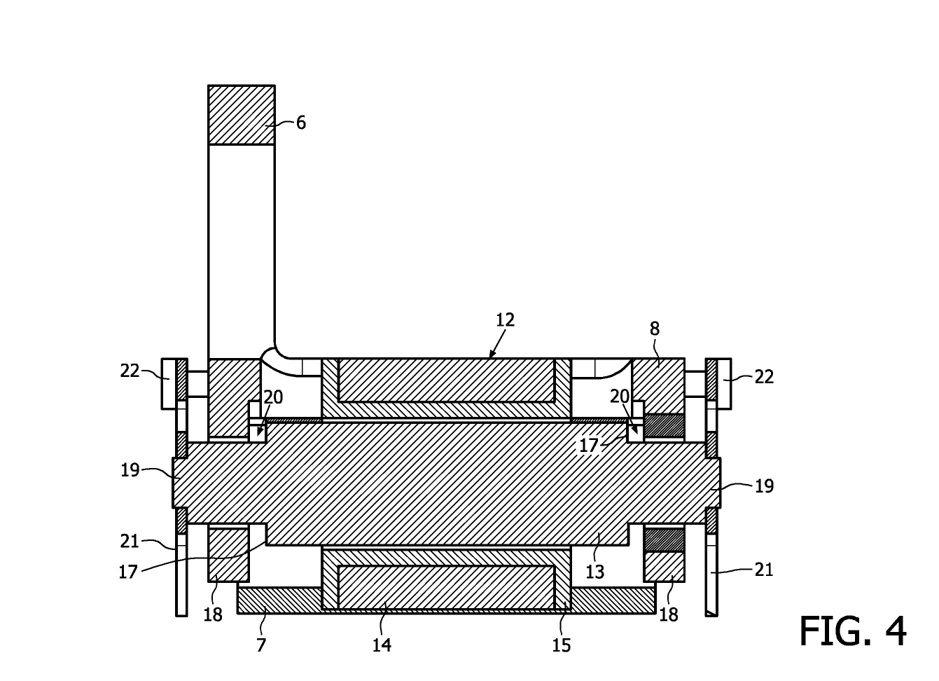

As is shown in FIG. 4, the translator magnet 13 is provided with shoulders 17 which are each adapted to co-operate with a respective portion 18 of the movable part that surrounds a smaller-diameter portion 19 at each end of the translator magnet 13. In FIG. 4 it is shown that there is a free space or free stroke 20 between each shoulder 17 and the respective portion 18 of the movable part 8 when the translator magnet 13 is in a rest position of the drive system. Because the drive system is adapted to operate in two opposite directions, the rest position is a central position of the translator magnet 13 with respect to the movable part 8.

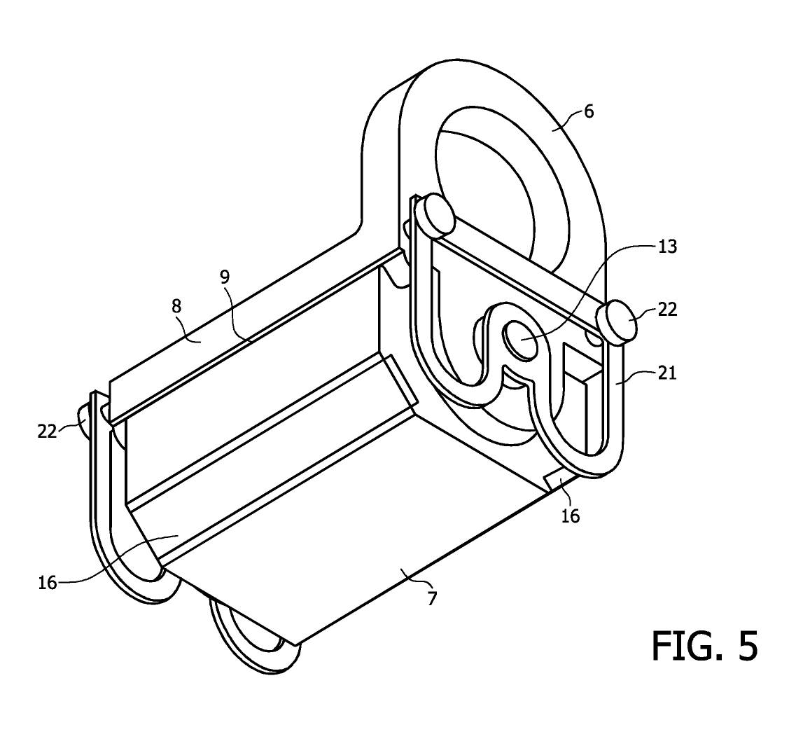

In order to bring the translator magnet 13 to the central rest position, there is provided a return mechanism which includes in this embodiment two spring members 21. One part of each spring member 21 is connected to the corresponding free end of the elongate translator magnet 13 which projects from the movable part 8. Another portion of each spring member 21 is attached to an adjacent portion of the movable part 8, in FIG. 5 by means of two mounting pins 22. These mounting pins 22 fix the respective spring member 21 in two positions, symmetrically with respect to the magnet mounting position of the spring member 21. The spring members 21 have a substantially flat design, so that these spring members 21 will hardly increase the size of the drive system.

When the translator magnet 13 moves with respect to the movable part 8, the spring members 21 will bend and the bending force will act on the translator magnet 13 in order to return it to a position in which the spring members 21 are unbent.

The operation of the drive system as shown in FIGS. 4-7 is as follows.

FIG. 4 shows the drive system in a rest position. The translator magnet 13 is in a central position with respect to the movable part 8 in which the spring members 21 are unbent and therefore do not exert a force onto the translator magnet 13 (the springs might exert equal forces in opposite directions). The translator magnet 13 is also in a central position with respect to the stator 12, which means that the lens holder 6 is in its central position and might be displaced in two opposite directions. The maximum stroke will generally be the length of the magnet 14 that projects outside the stator 12 or a more limited stroke determined by projection 10 on the movable part 8 and the stop faces 11 on the base 7.

In the position according to FIG. 4, when a current is directed through the coil 14 of the stator 12, the translator magnet 13 will be forced to the left or right, depending on the direction of the current. When the translator magnet starts to move, the only thing that will happen is that the spring members 21 are being bent. The bending stiffness of the spring members 21 is generally so low that the bending force is insufficient to overcome the static friction force of the movable part 8. Thus, the translator magnet 13 will continue to move until the free stroke 20 in one direction is reduced to zero and the respective shoulder 17 of the translator magnet 13 hits the respective portion 18 of the movable part 8. This collision will create a shock wave in the movable part 8 and due to this shock wave, the static friction will be overcome and the movable part 8 will start moving together with the translator magnet 13. If only a short current pulse was generated, the movable part 8 will move a distance depending on the energy transferred to the movable part 8 as a result of the mass and speed of the translator magnet 13.

As soon as the current in the coil 14 is interrupted and the impulse of the translator magnet is absorbed, the translator magnet 13 will be urged by the spring members 21 to its central rest position with respect to the movable part. As soon as the translator magnet 13 has reached its central rest position the drive system is ready for a new current pulse. The position of the movable part 8 will be measured and as long as the movable part 8 has not reached the desired position, a new current pulse will be generated to continue moving the movable part 8 further. The pulse frequency is preferably matched with the natural frequency of the drive system as this will reduce energy consumption.

As an alternative, the stator coil 14 is kept energized as long as the movable part 8 has not reached its desired position and the motor will only be de-energized as soon as the movable part 8 has reached its desired position which is sensed by a sensor.

In an application as the drive system of a collimator lens in an optical system of the disk drive unit, the drive system can be as small as ca. 6×5×4 mm with a maximum displacement of the lens of 0.75 mm. The smaller the maximum displacement of the movable part, the smaller the dimension of the drive system will be, especially in lengthwise direction.

As noted above, the lens holder 6 will move over a distance which depends on the amount of energy which is loaded into the moving translator magnet 13. The amount of energy depends on several parameters, such as free stroke of the translator magnet 13, mass of the translator magnet 13, magnet material and hence strength of the magnetic field, tension and stiffness of the spring members 21, electrical pulse steepness (pulse shape), current through the coil 14, etc.

The displacement of the lens holder 6 depends on parameters such as: amount of energy coming free out of the collision between the translator magnet 13 and the movable part 8, the (dynamic) friction between the movable part 8 and the base 7, mass of the assembly of movable part 8 and lens holder 6, any added damping, frequency and shape of the pulse (magnitude of the current and length of the pulse) etc.

It is possible to tune the drive system to its specific function by changing one or more of these parameters.

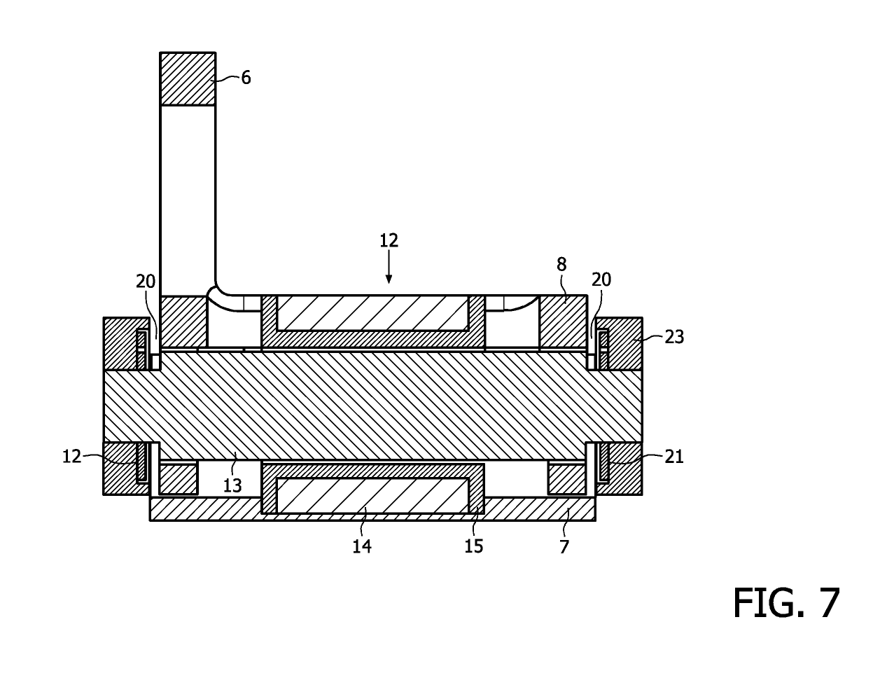

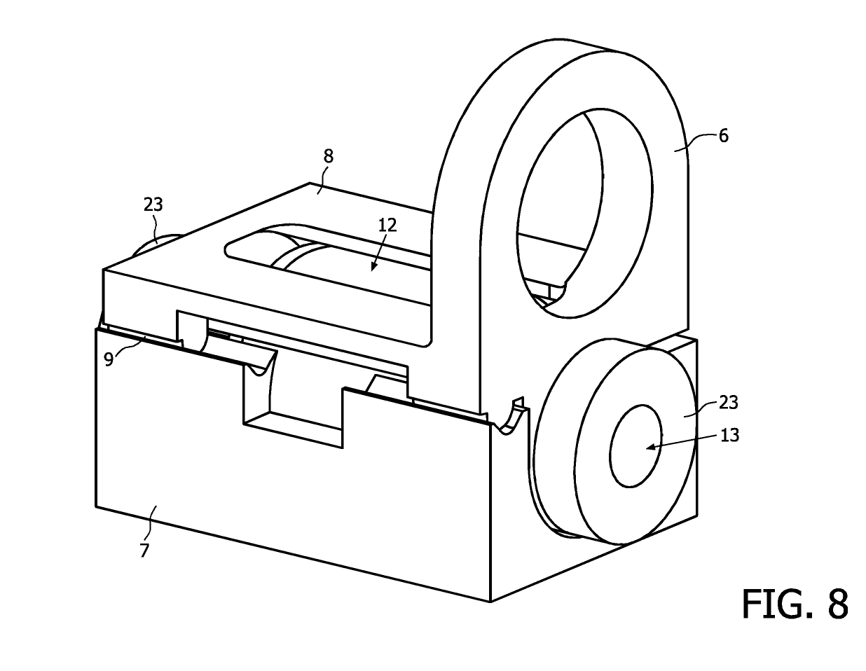

FIGS. 7 and 8 show a second embodiment of the drive system according to the invention in which the tuning is made possible by the use of one or more added masses 23 attached to the ends of the translator magnet 13. By means of these added masses 23 it is possible to vary the total weight of the translator 13 and thereby its impulse at a given current.

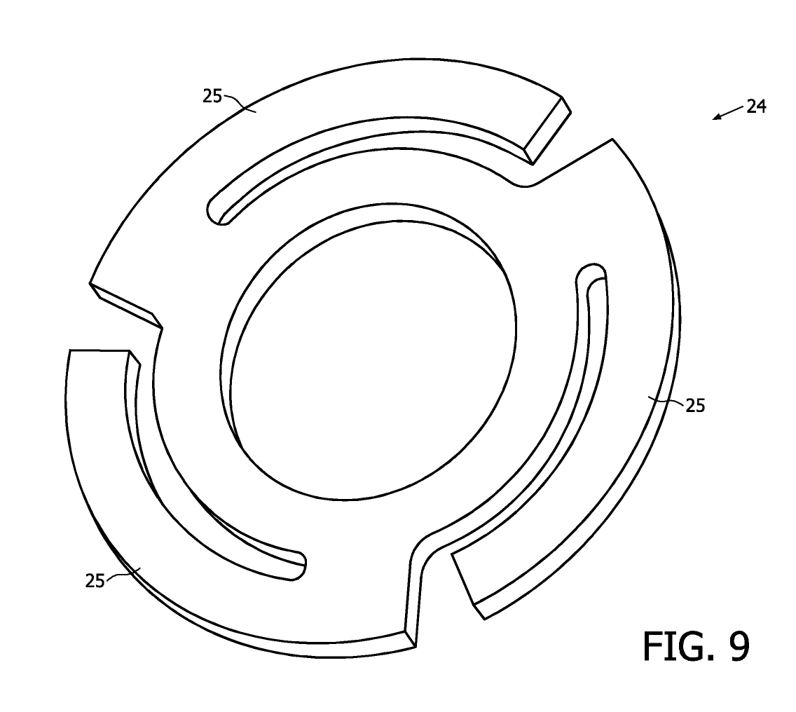

FIG. 9 shows an alternative embodiment of the return mechanism in the form of a spring 24 having a different shape. The spring has three arms 25, the free ends of which should be connected to the movable part 8.

From the foregoing it will be clear that the invention provides a drive system which can be made very small, is reliable, simple, and accurate and is efficient in view of energy consumption.

In the presently preferred embodiments, the disk D is an optical data disk. However, it should be understood that the invention can also be used for all kinds of disks, e.g. ferro-electric, magnetic, magneto-optic, optical, near-field, active charge storage disks or other disks using combinations of these techniques or other reading and/or writing techniques. Furthermore, the drive system according to the invention may be used in other applications, for example in motor driven zoom lenses in camera's, in medical devices, such as stethoscopes etc.

It is noted that in specification and claims, the term “a rotor/translator” indicates that the relevant component is a rotor or a translator. The use of the expressions “a” or “an” does not exclude a plurality thereof, whereas the expression “comprising” does no exclude additional elements or steps. Any reference signs in the claims shall not be construed as limiting the scope thereof.

The invention is not restricted to the above-described embodiment as shown in the drawing, which can be varied in several ways without departing from the scope of the appended claims. For example, the slidable engagement of the movable part and the base may be obtained in another way, for example purely mechanically. The return mechanism may include other mechanical parts or could also function electrically or the like.

1. A drive system for driving a movable part (8), comprising a base (7) including a guide (9) for guiding the movable part, a drive motor comprising a stator (12) fixed with respect to the base and a rotor/translator (13) movable with respect to the stator upon actuation, and a return mechanism (21) connected between the rotor/translator and the movable part for bringing the rotor/translator in a starting position with respect to the movable part in a rest condition of the drive motor, wherein a portion (18) of the movable part (8) is in the path of movement of the rotor/translator (13), and wherein there is a free stroke (20) between said portion of the movable part and the rotor/translator in the starting position of the rotor/ translator.

2. The drive system of claim 1, wherein the rotor/translator (13) is adapted to move in opposite directions, and the free stroke (20) of the rotor/translator is present in two opposite directions.

3. The drive system of claim 1, wherein the stator (12) co-operates with a translator (13) adapted to make a linear movement.

4. The drive system of claim 1, wherein the return mechanism (21, 22) includes at least one spring member (21).

5. The drive system of claim 4, wherein the translator (13) is an elongated member and one spring member (21) is connected between one end of the translator (13) and an adjacent portion of the base (7).

6. The drive system of claim 5, wherein the spring member (21) is a substantially flat spring positioned substantially transverse to the direction of movement of the drivable part (8).

7. The drive system of claim 1, wherein the stator (12) includes at least one coil (14) and the rotor/translator (13) comprises a magnet.

8. The drive system of claim 7, wherein the movable part (8) is guided on the base (7) by means of a linear guide (9), whereas the base includes at least one magnetizable member (16) positioned such that the interaction between the translator magnet (13) and the magnetizable member (16) keeps the movable part and the base in sliding engagement.

9. The drive system of claim 8, wherein the translator magnet (13) is positioned between the linear guide (9) and the magnetizable members (16).

10. The drive system of claim 1, wherein at least one mass is attached to the magnet.

11. The drive system of claim 5, wherein the drive control is adapted to energize the coils of the drive with a frequency matching the natural frequency of the drive system.

12. Disk drive unit comprising the drive system as claimed in claim 1 and comprising an optical system including an optical pickup unit and a rotatable turntable for supporting an optical disk.
